(19) United States
(12) Patent Application Publication
(10) Pub. No.: US 2026/0141432 A1
(43) Pub. Date: May 21, 2026

(54) USING MACHINE-LEARNING MODEL OF AN ONLINE SYSTEM TO GENERATE A SOURCE-RELATED CONFIDENCE SCORE FOR SERVICING A LIST OF COMPONENTS REQUESTED BY AN ONLINE PLATFORM

(71) Applicant: Maplebear Inc., San Francisco, CA (US)

(72) Inventors: Naval Shah, Toronto (CA); Riddhima Sejpal, Dublin, CA (US)

(21) Appl. No.: 18/951,399

(22) Filed: Nov. 18, 2024

(51) Int. Cl. G06Q 30/0601

(52) U.S. Cl. CPC G06Q 30/0623; G06Q 30/0633; G06Q 30/0603

(57) ABSTRACT

An online system uses a trained machine-learning model to generate a confidence score for servicing a list of components (e.g., recipe) at a specific source. Upon receiving the list of components from an online platform, the online system identifies a set of candidate items that match each component from the list. The online system further identifies a matching score and a number of matches for each component. The online system then applies the machine-learning model to the matching score, the number of matches, and user’s conversion data to generate a confidence score for the list of components that is indicative of a likelihood that the list of components are located at the source. The online system selects the list of components for the source and sends the list of components and an identification of the source for displaying at a user’s device.

### BACKGROUND

Online systems allow their users to browse and acquire items by placing online orders. Additionally, the online systems allow their users to build lists of items for acquisition outside of online system platforms, such as from third-party applications or offsite recipes. A third-party application recommends recipes to users of an online system, and the user can acquire the ingredients on the online system platform. An application programming interface (API) of the online system is extensively used by third-party developers and applications, particularly the platforms that host recipes. These platforms allow their users to use the online system to fulfill deliveries for ingredients listed in proprietary recipes. Instead of manually shopping for groceries, the application sends its user to the online system, where the online system matches the recipe ingredients with available items, facilitating an online purchase and delivery service.

However, it can be a disappointing experience when the user selects a recipe but then the user’s preferred source (e.g., retailer) does not have all items of the recipe in stock. This problem arises when an API interface of the online system accepts a list of ingredients from an outside platform, but upon the user’s arrival on a site of the online system, critical ingredients may be out of stock or unavailable through a selected source, and the user encounters the obstacle in completing their transaction. In other words, the user has chosen the source and is browsing recipes, and the user is often sent to the online system when all ingredients of the recipe are not able to be fulfilled, which results in a poor user experience. This occurs because third-party sites and applications that are recipe-centric do not have enough information to determine on their own whether for a given source and region, the recipe ingredients are in stock. However, the online system may wish to avoid sharing an item catalog database with the third-party applications. The item catalog database may be too big, and it may be updated too often. Additionally, the data stored in the item catalog database may be sensitive for security and privacy reasons.

### SUMMARY

Embodiments of the present disclosure are directed to using a trained machine-learning model of an online system to generate a confidence score for servicing a list of components (e.g., list or items, list of ingredients, or recipe) at a specific source associated with the online system, wherein the servicing (e.g., fulfillment) of the list of components is requested by an online platform (e.g., third-party application) that is outside of the online system.

In accordance with one or more aspects of the disclosure, the online system receives, from an online platform and via an interface of the online system, a request signal including a list of components and an identity of a user of the online system. Responsive to the received request signal, the online system identifies, from an item database of the online system, a set of one or more candidate items that match each component from the list. The online system compares each component from the list with one or more embeddings of the set of one or more candidate items to generate a matching score indicating how much each component from the list matches the set of one or more candidate items. The online system identifies a number of matches for each component from the list indicating a number of candidate items in the set of one or more candidate items. The online system accesses a scoring machine-learning model of the online system, wherein the scoring machine-learning model is trained using information about past engagements of a collection of users of the online system with a plurality of lists of components to predict a likelihood that the list of components are located at a source. The online system applies the scoring machine-learning model to the matching score for each component from the list, the number of matches for each component from the list, and past conversion data for the user to generate a confidence score for the list of components that is indicative of the likelihood that the list of components are located at the source. The online compares the confidence score to a threshold score. The online system selects, based on identifying that the confidence score meets or exceeds the threshold score, the list of components for the source. Responsive to selecting the list of components for the source, the online system generates a user interface signal. The online system sends, via a network, the user interface signal to a device associated with the user, wherein the sending causes the device to display a user interface with the list of components and an identification of the source where the list of components are located.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates an example architectural flow diagram of using a trained machine-learning model of an online system to generate a confidence score for servicing a list of components at a specific source associated with the online system, in accordance with one or more embodiments.

FIG. 4 is a flowchart for a method of using a trained machine-learning model of an online system to generate a confidence score for servicing a list of components at a specific source associated with the online system, in accordance with one or more embodiments.

### DETAILED DESCRIPTION

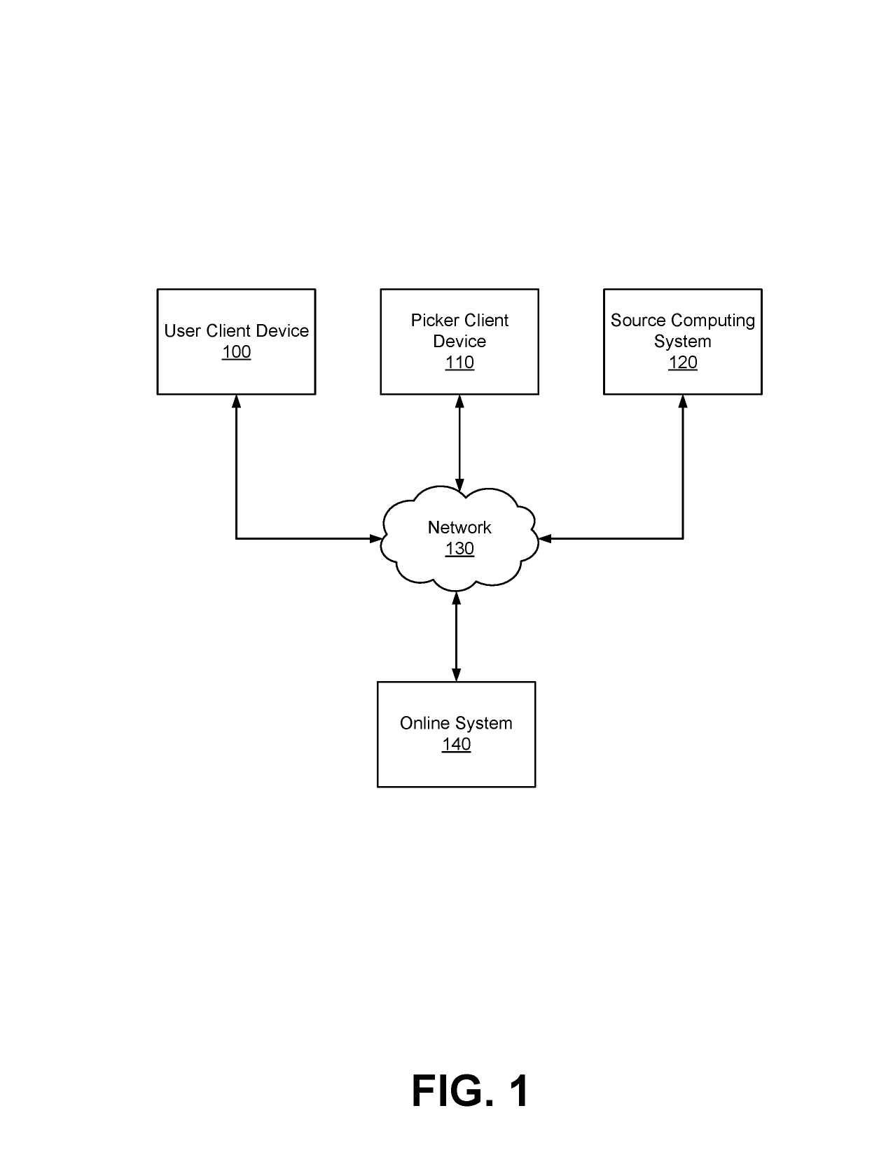

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker (i.e., fulfillment agent, servicing agent, or agent) that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed April 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a source location. The user’s order may specify which groceries they want to be delivered from the source location and the quantities of each of the groceries. The user client device 100 transmits the user’s order to the online system 140 and the online system 140 selects a picker to travel to the source location to collect the groceries ordered by the user. The online system transmits an offer to the picker for the picker to service the order in exchange for consideration and, if the picker accepts the offer, the picker collects the groceries from the source location. Once the picker has collected the groceries ordered by the user, the picker delivers the groceries to a location transmitted to the picker client device 110 by the online system 140.

The online system 140 may fulfill orders generated from lists of items (e.g., recipes) created by third-party applications. Because the third-party applications do not know the sources for fulfilling the items in the lists, or otherwise have an ability to predict inventory status for the source, the third-party applications do not know whether a particular list can be fulfilled for a particular user. This prevents the third-party applications from ranking and selecting lists of items to show users based on an ability to convert on them. To address this, the third-party applications send requests (e.g., via an application programming interface (API)) to the online system 140, specifying the list content (e.g., recipe content) and the user. The online system 140 then uses a trained machine-learning model to generate a confidence score that a particular list of items (e.g., recipe) can be fulfilled for a particular user, and the online system 140 responds to the third-party application with the confidence scores, thereby enabling the third-party application to select lists to show to users in a more informed manner.

The online system 140 may deploy the trained machine-learning model to generate a confidence score that a recipe can be fulfilled by the online system 140 using the user’s preferred source. The confidence score may be a value between 0 and 1, where a higher value for the confidence score indicates a higher level of confidence that a recipe can be fulfilled by the online system 140 using a specific source associated with the online system 140. The machine-learning model may be trained on a set of users’ activities in relation to recipes maintained by the online system 140 (e.g., at the data store 240), and given how internal search results are returned for each ingredient / line item of a recipe, including information on whether the recipe ingredients are ultimately matched and available for the user to convert on.

Once the trained machine-learning model provides a confidence score for fulfillment of a recipe, given a specific source and source location, this functionality of the online system 140 may enable third-party applications to filter out and present only those recipes that have a high likelihood of item availability and ‘serviceability’ through the online system 140. By integrating the confidence score provided by the online system 140, the third-party applications can ensure that the recipes shown to users are more likely to result in successful transactions. This is beneficial in multiple ways: users experience seamless transactions without encountering dead ends; third-party developers experience improved users’ satisfaction and engagement on their platforms; and the online system 140 enhances service reliability and satisfaction without exposing proprietary catalog or inventory details. Furthermore, the approach presented herein ensures that the online system 140 does not need to share a source’s catalog with third-party applications. This reduces the additional complexity for the third-party applications by eliminating the need to ingest large volumes of data and manually process the data periodically to calculate their own confidence scores.

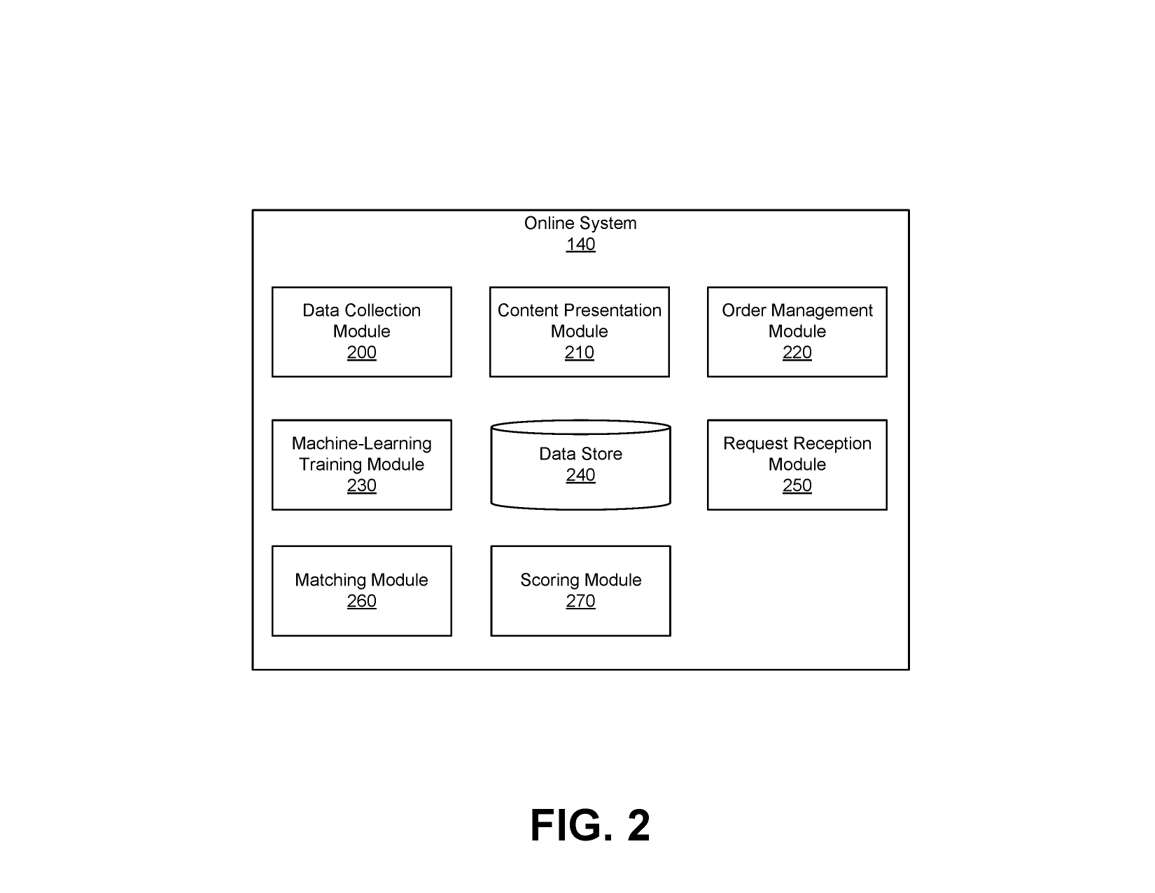

Note that in the third-party applications, since the user selects a source at the outset, the online system 140 can tailor the displayed recipes based on their confidence scores, thereby optimizing the shopping experience from the very beginning. Using the confidence scores provided by the online system 140, the third-party application will be able to highlight recipes that will be successfully fulfilled, and alternately will be able to hide or down-prioritize recipes where the confidence score for fulfillment is low. Additionally, the usage of confidence scores allows third-party applications to emulate an item inventory without the online system 140 having to share every source catalog with the third parties. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a request reception module 250, a matching module 260, and a scoring module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The process of the online system 140 presented herein provides a confidence score for servicing (i.e., fulfillment) of a given recipe (i.e., list of ingredients or items) in relation to a specific source and source location. This process ensures that third-party applications can effectively display recipes with a high likelihood of being fulfillable through the online system 140. The process is divided into two main phases: (1) the ingredient relevance and availability determination phase, and (2) the confidence score calculation phase.

The process flow may start when the request reception module 250 receives a list of items or ingredients (e.g., recipe) for acquisition, e.g., from a third-party application. For example, a user is using a third-party application (e.g., website or native application on the user client device 100), and the third-party application wants to display a shoppable list of items or ingredients (e.g., recipe) to the user. The third-party application may be ranking or otherwise selecting a list to show to the user from a set of candidate lists. The request reception module 250 may receive a request (e.g., API call) from the third-party application in relation to the list. The request may include the list and an identity of the user. The request may also provide filters and/or preferences for finding items in the list. Furthermore, the request may also specify a source (e.g., retailer) for fulfilling the list. The request reception module 250 may parse the list and any additional information included in the request and provide the parsed data to the matching module 260.

The matching module 260 may determine a relevance and availability of each component of the list (e.g., item or ingredient). If the list is specified generically (e.g., by providing category of ingredients, not actual items or products), then the matching module 260 may generate a list of specific items that satisfy the received list. Alternatively, the matching module 260 may identify multiple candidate items that match each ingredient from the received list. For each candidate item and a corresponding source, the matching module 260 may apply the availability model to predict a likelihood that each candidate item can be fulfilled using a specific source associated with the online system 140.

Additionally, the matching module 260 may filter out common pantry items, or any other items for which there is a high confidence that the user already have them (e.g., when the user recently converted on specific items). The matching module 260 may also select one or more sources (e.g., one or more retailers) for fulfilling the list. The source selection may be personalized, i.e., based on user’s conversion history and user’s preferences (e.g., available in a user catalog database of the data store 240).

In one or more embodiments, the request reception module 250 provides a set of inputs to the matching module 260 including a name of each ingredient in the list and information about additional filters for filtering item matching, such as brand preferences, health tags, etc. The matching module 260 may query a search engine of the online system 140 with a high relevance for each ingredient in the list. This search process may utilize item catalog backends of the online system 140 to return relevancy scores and the number of matches for each ingredient in the list. The results from these queries may provide insights into the availability and relevancy of each ingredient in the list at the selected source and source location. The matching module 260 may output relevancy scores indicating how well each ingredient in the list matches the available items, as well as a number of matches indicating a number of available items that match each ingredient in the list. The matching module 260 may compare each ingredient in the list with embeddings (e.g., categories, types, classes, etc.) of the available items to determine a relevancy score for each ingredient in the list.

The scoring module 270 may generate a confidence score that is indicative of a likelihood that the online system 140 is able to fulfill the list when utilizing a specific source associated with the online system 140. The scoring module 270 may generate an overall confidence score for the entire list. In one or more embodiments, the scoring module 270 generates the overall confidence score as a function that aggregates the individual item relevancy scores provided by the matching module 260. In one or more other embodiments, the scoring module 270 applies a machine-learning model to various input features to generate the overall confidence score, wherein the machine-learning model is trained on past experiences whether a list of components (e.g., ingredients) was fulfillable.

The scoring module 270 may access a scoring model (e.g., machine-learning model) that is trained to predict a likelihood that a list of ingredients (e.g., recipe) will be serviced by the online system 140 using a specific source associated with the online system 140. The scoring module 270 may deploy the scoring model to run a machine-learning algorithm to a set of inputs to generate a confidence score that is indicative of the likelihood that the list of ingredients (e.g., recipe) will be serviced by the online system 140 using the specific source. The confidence score may be a value between 0 and 1, where a higher value of the confidence score may indicate a higher level of likelihood that the list of ingredients (e.g., recipe) will be serviced by the online system 140 using the specific source. A set of parameters for the scoring model may be stored at one or more non-transitory computer-readable media of the scoring module 270. Alternatively, the set of parameters for the scoring model may be stored at one or more non-transitory computer-readable media of the data store 240.

The scoring model may be thus trained to output a confidence score between 0 and 1 representing a likelihood for successful fulfillment of <recipe, source, source location> triple, i.e., the likelihood of fulfilling the recipe ingredients using the specific source and source location. The confidence score output by the scoring model may be personalized if user context (e.g., user’s recent purchase history) is available; otherwise, the scoring model may rely on generic data such as the pantry list.

In providing the input signals to the scoring model, the scoring module 270 may provide relevancy scores and a number of matches for each ingredient in the list as generated by the matching module 260. In providing the input signals to the scoring model, the scoring module 270 may further provide the user’s context data including information about the user’s recent purchase history. The scoring module 270 may retrieve the user’s context data from a user catalog database (e.g., stored at the data store 240). In providing the input signals to the scoring model, the scoring module 270 may further provide a list of pantry items (e.g., items commonly owned by users of the online system 140). The list of pantry items may be personalized based on the user’s context data. Alternatively, if the user’s context data are not available, the list of pantry items may include a generic list of items (e.g., retrieved by the scoring module 270 from the data store 240). In providing the input signals to the scoring model, the scoring module 270 may further provide activity data including historical data from a recipe landing page about how users previously interacted with the same recipe ingredients.

The scoring model may therefore integrate the inputs generated by the matching module 260 along with additional contextual data such as user’s context data and a list of pantry items. The scoring model may be trained on existing activity data to predict the likelihood of successfully fulfilling the recipe ingredients. The output of the scoring model is a confidence score ranging from 0 to 1, representing a likelihood that the recipe ingredients are fulfillable using a specific source (and, optionally, a source location).

The machine-learning training module 230 may perform initial training of the scoring model using training data. The machine-learning training module 230 may generate the training data including information about a set of users’ past activities in relation to recipes (e.g., maintained by the online system 140 at the data store and/or collected from third-party applications), and given how internal search results are returned for each ingredient and/or item of a recipe, including information on whether the recipe ingredients are ultimately matched and available for the user to convert on. The machine-learning training module 230 may train the scoring model using the training data to generate initial values for the set of parameters of the scoring model.

The scoring module 270 may respond to the third-party application with the confidence score for the list of ingredients. The third-party application may then utilize the confidence score to make a decision about whether to show this specific list of ingredients to the user. For example, the third-party application may compare the confidence score with a threshold score and show the list to the user if the confidence score is greater than the threshold score. Alternatively, the third-party application may rank multiple lists of ingredients (e.g., recipes) based on their confidence scores, and then select for presentation to the user a defined number of lists having highest confidence scores. Alternatively, the third-party application may compute an expected value for the list using the confidence score as a likelihood of being able to convert on items from the list (e.g., recipe ingredients) affects the expected value of the list. The third-party application may rank multiple lists of ingredients (e.g., recipes) based on their expected values, and then select for presentation to the user a defined number of lists having highest expected values.

In one or more embodiments, a third-party application requests a ranked list of sources for fulfilling a list of ingredients (e.g., recipe). In such cases, the third-party application may specify a set of sources for evaluation in an API call, and the scoring module 270 may respond to the third-party application with a confidence score obtaining the list for each source from the specified set of sources. Alternatively, the scoring module 270 may respond to the third-party application with a ranked list of sources for obtaining the list.

In one or more embodiments, the online system 140 applies the trained scoring model to provide to third-party developers with recipe ranking and prioritization. The process flow starts with a user’s selection at a third-party application, i.e., the user initiates the flow by selecting, on the third-party application, a preferred source and providing a preferred source location. The user’s selection stage may be then followed by a recipe ingredient query stage. During this stage of the process flow, the third-party application may gather lists of ingredients for a set of recipes and sends them, along with any relevant filters (e.g., brand preferences, health tags), to an API endpoint of the online system 140 (e.g., the request reception module 250).

The recipe ingredient query stage may be then followed by a relevancy and availability checking stage. During this stage of the process flow, the matching module 260 may process the search queries by leveraging catalog backends of the online system 140 to obtain relevancy scores and a number of matches for each ingredient. The relevancy scores and the number of matches generated by the matching module 260 may indicate how well each ingredient matches the available items at the selected source and source location.

The relevancy and availability checking stage may be then followed by a confidence score calculation stage. During this stage of the process flow, the outputs from the relevancy and availability checking stage (e.g., the relevancy scores and number of matches for each ingredient), along with additional contextual data (e.g., user’s context, pantry items, and historical activity data) may be fed into the scoring model, e.g., via the scoring module 270. The scoring model may then compute a confidence score between 0 and 1 for each list of ingredients (e.g., recipe) provided by the third-party application, which represents a likelihood of fulfilling ingredients of each recipe at the selected source and source location.

The confidence score calculation stage may be then followed by a recipe prioritization stage. During this stage of the process flow, the third-party application may use the confidence scores obtained from the scoring model of the online system 140 to rank and prioritize recipes, presenting the user with a subset of recipes that have higher confidence scores, ensuring better chances of fulfillment.

The confidence score calculation stage may be then followed by a user experience stage. During this stage of the process flow, the user is shown with those recipes that are more likely to be fulfillable by the online system 140, enabling a seamless transition from recipe selection to ingredient purchase and delivery. Thus, the process flow enhances the user experience by reducing dead ends and improving transaction success rates.

In one or more other embodiments, the online system 140 applies the trained scoring model to enhance recipe features of the online system 140. In such cases, the online system 140 may integrate the presented confidence scoring system into its own recipes feature, i.e., the online system 140 may perform the recipe feature integration of the presented confidence scoring system. Users can utilize a platform of the online system 140 to browse recipes, with the online system 140 automatically showing those recipes with high confidence scores for servicing based on the user’s preferred source and source location. It should be noted that, for a user’s better experience, a recipe is often selected before a source is selected. The online system 140 may then run the integrated confidence scoring system to rank a set of sources that the online system 140 pre-selects for a given recipe, thus ensuring a good user’s experience (i.e., seamless shopping experience). The integration of the confidence scoring system into the online system 140 ensures that users of the online system 140 can easily find recipes that have ingredients readily available, streamlining the conversion and delivery process.

The machine-learning training module 230 may collect feedback data with information about whether ingredients of a recipe that is presented to a user of a third-party application (or user of the online system 140) are indeed readily available at a specific source and source location. This information may be recorded at the user client device 100, the picker client device 110 and/or the source computing system 120 and communicated, via the network 130, to the online system 140 and the machine-learning training module 230 as the feedback data. The machine-learning training module 230 may then re-train the scoring model by updating the set of parameters of the scoring model using the feedback data. If any of the ingredients is not available at the specific source and source location, this information would be used as a negative reinforcement for re-training of the scoring model. In contrast, if all ingredients of the recipe are indeed available at the specific source and source location as predicted by the scoring model, this information would be used as a positive reinforcement for re-training of the scoring model.

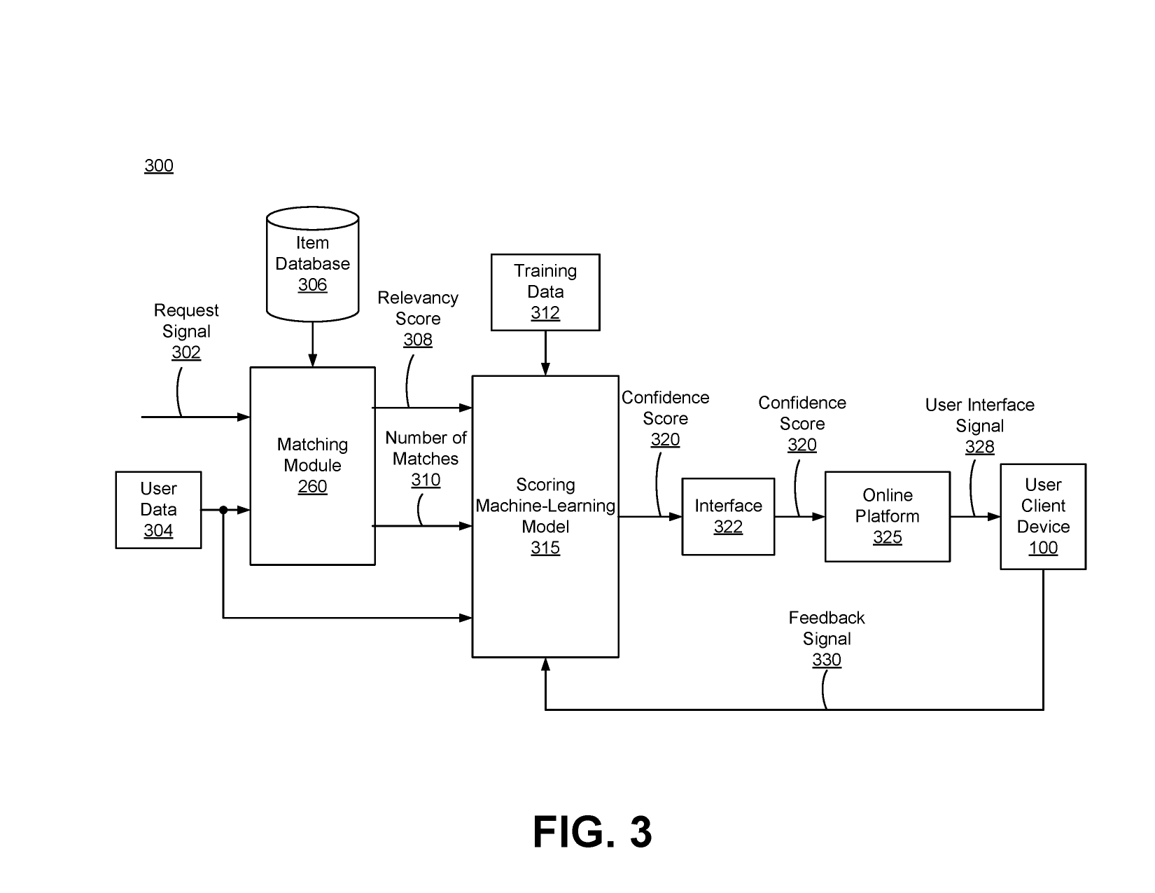

FIG. 3 illustrates an example architectural flow diagram 300 of using a scoring machine-learning model 315 of the online system 140 to generate a confidence score for servicing a list of ingredients (e.g., recipe) at a specific source associated with the online system 140, in accordance with one or more embodiments. The process flow may be initiated (e.g., via the request reception module 250) upon receiving (e.g., from a third-party application) a request signal 302 including the list of ingredients and an identity of a user of the online system 140. After parsing the request signal 302, the request reception module 250 may pass the request signal 302 including the list of ingredients and the identity of the user to the matching module 260. Using information about the identity of the user, the matching module 260 may retrieve (e.g., from a user catalog database at the data store 240) user data 304 including past conversion data for the user (e.g., user’s purchase history).

In one or more embodiments, the request signal 302 further includes an identification of a source for servicing the list of ingredients. Alternatively, the matching module 260 may identify a user’s preferred source based on the user data 304. The matching module 260 may identify, from an item database 306 (e.g., stored at the data store 240), a set of one or more candidate items that match each component from the list and are predicted to be available at the source. Based on the set of one or more candidate items, the matching module 260 may identify a relevancy score 308 for each ingredient from the list that indicates a level of matching relevancy between each ingredient from the list and the set of one or more candidate items. The matching module 260 may further output a number of matches 310 for each ingredient from the list that indicates a number of candidate items predicted to be available at the source that match each ingredient from the list (i.e., a number of the one or more candidate items in the set). The matching module 260 may pass the relevancy score 308 for each ingredient from the list and the number of matches 310 for each ingredient from the list to the scoring machine-learning model 315.

Prior to running a machine-learning algorithm of the scoring machine-learning model 315, the online system 140 may perform (e.g., via the machine-learning training module 230) initial training of the scoring machine-learning model 315 using training data 312 to generate initial values for a set of parameters of the scoring machine-learning model 315. The training data 312 may be generated (e.g., via the machine-learning training module 230) to include information about past engagements of a collection of users of the online system 140 with a plurality of lists of ingredients (e.g., recipes) and information about availability of each component from the plurality of lists for conversion by a user from the collection of users.

After the training is completed, the scoring machine-learning model 315 may apply the machine-learning algorithm to the relevancy score 308 for each ingredient from the list, the number of matches 310 for each ingredient from the list, and the user data 304 to output a confidence score 320 (e.g., value between 0 and 1) for the list of ingredients that indicates a likelihood of servicing the list of items using the source. The scoring machine-learning model 315 may send, via an interface 322 (e.g., API), confidence score 320 for the list of ingredients to an online platform 325 (e.g., third-party application).

The online platform 325 may use the confidence score 320 for determining whether to display the list of ingredients at a user interface of the user client device 100. In one or more embodiments, when the confidence score 320 is greater than a threshold score (or greater than one or more confidence scores of one or more lists of ingredients), the online platform 325 generates a user interface signal 328 that cause the user interface of the user client device 100 to display the list of ingredients, information about the source for servicing the list of ingredients, and a prompt for the user to utilize the online system 140 for fulfillment of an order that includes the list of ingredients.

The user client device 100 (or, alternatively, the picker client device 110) may generate and record a feedback signal 330 with information about whether each ingredient from the list was available for conversion at the source. The online system 140 may receive (e.g., at the machine-learning training module 230) the feedback signal 330 from the user client device 100 (or, alternatively, the picker client device 110) via the network 130. The machine-learning training module 230 may utilize the feedback signal 330 to re-train the scoring machine-learning model 315. By utilizing feedback signals 330 from various users and/or pickers over time, the machine-learning training module 230 may continuously update the set of parameters of the scoring machine-learning model 315 and continuously improve the machine-learning algorithm of the scoring machine-learning model 315.

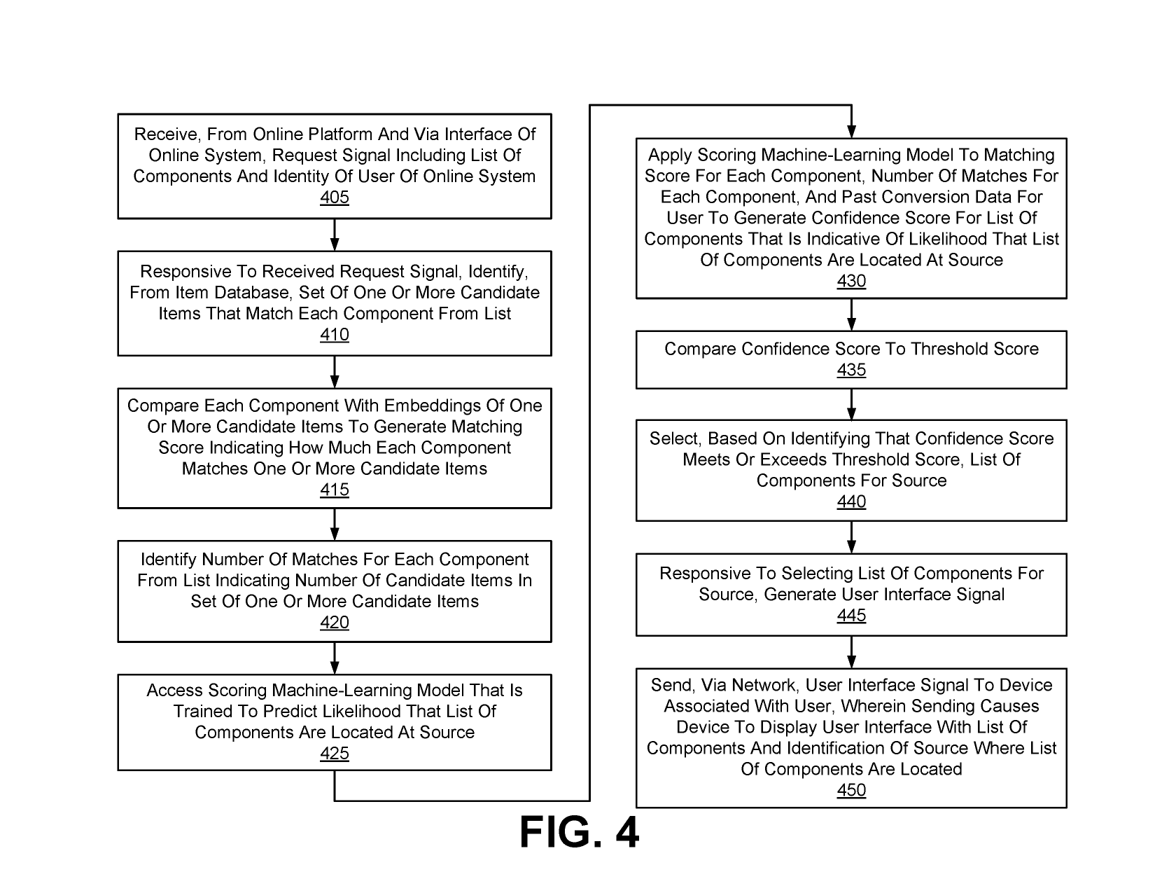

FIG. 4 is a flowchart for a method of using a trained machine-learning model of an online system to generate a confidence score for servicing a list of components (e.g., recipe) at a specific source associated with the online system, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 receives 405 (e.g., at the request reception module 250), from an online platform (e.g., third-party application) and via an interface (e.g., API) of the online system 140, a request signal including a list of components (e.g., list of ingredients or recipe) and an identity of a user of the online system 140. The online system 140 may receive (e.g., at the request reception module 250), from the online platform and via the interface of the online system 140, the request signal including information about a set of filters for filtering the item database to identify the set of one or more candidate items that match each component from the list. Alternatively or additionally, the online system 140 may receive, from the online platform and via the interface of the online system 140, the request signal including information about the source for servicing the list of components.

Responsive to the received request signal, the online system 140 identifies 410 (e.g., via the matching module 260), from an item database of the online system 140 (e.g., at the data store 240), a set of one or more candidate items that match each component from the list. The online system compares 415 (e.g., via the matching module 260) each component from the list with one or more embeddings of the set of one or more candidate items to generate a matching score indicating how much each component from the list matches the set of one or more candidate items. The online system identifies 420 (e.g., via the matching module 260) a number of matches for each component from the list indicating a number of candidate items in the set of one or more candidate items.

Response to the received request signal, the online system 140 may identify (e.g., via the matching module 260), from the item database, an initial set of candidate items that match each component from the list. The online system 140 may then apply, for each component from the list, an availability machine-learning model of the online system 140 (e.g., via the matching module 260) to information about each candidate item from the initial set and inventory data related to the source to generate an availability score that is indicative of a likelihood of availability of each candidate item at a source. The online system 140 may select (e.g., via the matching module 260), for each component from the list and based on the availability score for each candidate item, the set of one or more candidate items from the initial set of candidate items, wherein the set of one or more candidate items are predicted to be available at the source. The online system 140 may further filter (e.g., via the matching module 260), based at least in part on the past conversion data for the user, one or more candidate items from the initial set of candidate items to identify the set of one or more candidate items for each component from the list. The online system 140 may also select (e.g., via the matching module 260), based at least in part on information about the user (e.g., user’s purchase history), the source for servicing the list of components.

The online system 140 accesses 425 a scoring machine-learning model of the online system 140 (e.g., via the scoring module 270), wherein the scoring machine-learning model is trained using information about past engagements of a collection of users of the online system 140 with a plurality of lists of components (e.g., recipes) to predict a likelihood that the list of components are located at the source. The online system 140 applies 430 the scoring machine-learning model (e.g., via the scoring module 270) to the matching score for each component from the list, the number of matches for each component from the list, and past conversion data for the user to generate a confidence score for the list of components that is indicative of the likelihood that the list of components are located at the source.

The online system 140 may generate (e.g., via the machine-learning training module 230) training data including the information about past engagements of the collection of users of the online system 140 with the plurality of lists of components and information about availability of each component from the plurality of lists for conversion by a user from the collection of users. The online system 140 may train (e.g., via the machine-learning training module 230), using the training data, the scoring machine-learning model to generate a set of initial values for a set of parameters of the scoring machine-learning model.

The online system 140 may receive (e.g., at the machine-learning training module 230), from the device associated with the user and via a network (e.g., the network 130), feedback data with information about whether each component from the list was available for conversion at the source. The online system 140 may re-train the scoring machine-learning model by updating (e.g., via the machine-learning training module 230), using the feedback data, the set of parameters of the scoring machine-learning model.

The online system 140 compares 435 (e.g., via the scoring module 270) the confidence score to a threshold score. The online system 140 selects 440 (e.g., via the scoring module 270), based on identifying that the confidence score meets or exceeds the threshold score, the list of components for the source. Responsive to selecting the list of components for the source, the online system 140 generates 445 (e.g., via the content presentation module 210) a user interface signal. The online system 140 sends 450 (e.g., via the content presentation module 210), via a network (e.g., the network 130), the user interface signal to a device associated with the user (e.g., the user client device 100), wherein the sending causes the device to display a user interface with the list of components and an identification of the source where the list of components are located.

In one or more embodiments, the online system 140 sends (e.g., via the scoring module 270), via the interface, the confidence score to the online platform, wherein the sending causes the online platform to use the confidence score for ranking a plurality of lists of components and determining one or more of the plurality of lists of components to display at the user interface of the device associated with the user.

The online system 140 may receive (e.g., at the request reception module 250) the request signal including a list of candidate sources for servicing the list of components. The online system 140 may apply the scoring machine-learning model (e.g., via the scoring module 270) to generate the confidence score of a list of candidate scores that is indicative of the likelihood that the list of components are located at each candidate source from the list of candidate sources. The online system 140 may send (e.g., via the scoring module 270), via the interface, the list of confidence scores to the online platform, wherein the sending causes the online platform to use the list of candidate scores to select the source for servicing the list of components and display the user interface with the list of components and the selected source for servicing the list.

The online system 140 may receive (e.g., at the request reception module 250) the request signal including a list of candidate sources for servicing the list of components. The online system 140 may apply the scoring machine-learning model (e.g., via the scoring module 270) to generate the confidence score of a list of candidate scores that is indicative of the likelihood that the list of components are located at each candidate source from the list of candidate sources. The online system 140 may rank (e.g., via the scoring module 270), using the list of candidate scores, the list of candidate sources to generate a ranked list of candidate sources. The online system 140 may send, via the interface, the ranked list of candidate sources to the online platform, wherein the sending causes the online platform to use the ranked list of candidate sources to select the source for servicing the list of components and display the user interface with the list of components and the selected source for servicing the list.

Embodiments of the present disclosure are directed to the online system 140 that utilizes a trained machine-learning model to generate a confidence score for servicing a list of items (e.g., recipe) at a specific source associated with the online system 140. The list of items may be received from a third party. The machine-learning model is trained to generate the confidence score for obtaining items in the list from the specific source. The machine-learning model may also determine which source to use, e.g., based on the user’s personalization.

The two-phase approach presented herein allows third-party applications to filter and display only those recipes with a high confidence score, ensuring a more seamless and fulfilling servicing experience for users, while enhancing the value propositions for both third-party developers and the online system 140. By leveraging this approach, both third-party developers and the online system 140 can present recipes with higher fulfillment confidence, leading to improved users’ satisfaction and increased transaction success.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving, from an online platform and via an interface of an online system, a request signal including a list of components and an identity of a user of the online system;
responsive to the received request signal, identifying, from an item database of the online system, a set of one or more candidate items that match each component from the list;
comparing each component from the list with one or more embeddings of the set of one or more candidate items to generate a matching score indicating how much each component from the list matches the set of one or more candidate items;
identifying a number of matches for each component from the list indicating a number of candidate items in the set of one or more candidate items;
accessing a scoring machine-learning model of the online system, wherein the scoring machine-learning model is trained using information about past engagements of a collection of users of the online system with a plurality of lists of components to predict a likelihood that the list of components are located at a source;
applying the scoring machine-learning model to the matching score for each component from the list, the number of matches for each component from the list, and past conversion data for the user to generate a confidence score for the list of components that is indicative of the likelihood that the list of components are located at the source;
comparing the confidence score to a threshold score;
selecting, based on identifying that the confidence score meets or exceeds the threshold score, the list of components for the source;
responsive to selecting the list of components for the source, generating a user interface signal; and
sending, via a network, the user interface signal to a device associated with the user, wherein the sending causes the device to display a user interface with the list of components and an identification of the source where the list of components are located.

2. The method of claim 1, wherein receiving the request signal comprises:
receiving, from the online platform and via the interface of the online system, the request signal including information about a set of filters for filtering the item database to identify the set of one or more candidate items that match each component from the list.

3. The method of claim 1, wherein receiving the request signal comprises:
receiving, from the online platform and via the interface of the online system, the request signal including information about the source for servicing the list of components.

4. The method of claim 1, wherein identifying the set of one or more items comprises:
responsive to the received request signal, identifying, from the item database, an initial set of candidate items that match each component from the list;
applying, for each component from the list, an availability machine-learning model to information about each candidate item from the initial set and inventory data related to the source to generate an availability score that is indicative of a likelihood of availability of each candidate item at the source; and
selecting, for each component from the list and based on the availability score for each candidate item, the set of one or more candidate items from the initial set of candidate items, the set of one or more candidate items are predicted to be available at the source.

5. The method of claim 4, wherein identifying the set of one or more candidate items further comprises:
filtering, based at least in part on the past conversion data for the user, one or more candidate items from the initial set of candidate items to identify the set of one or more candidate items for each component from the list.

6. The method of claim 1, further comprising:
selecting, based at least in part on information about the user, the source for servicing the list of components.

7. The method of claim 1, further comprising:
generating training data including the information about past engagements of the collection of users of the online system with the plurality of lists of components and information about availability of each component from the plurality of lists for conversion by a user from the collection of users; and
training, using the training data, the scoring machine-learning model to generate a set of initial values for a set of parameters of the scoring machine-learning model.

8. The method of claim 1, further comprising:
receiving, from the device associated with the user and via a network, feedback data with information about whether each component from the list was available for conversion at the source; and
re-training the scoring machine-learning model by updating, using the feedback data, a set of parameters of the scoring machine-learning model.

9. The method of claim 1, further comprising:
sending, via the interface, the confidence score to the online platform, wherein the sending causes the online platform to use the confidence score for ranking a plurality of lists of components and determining one or more of the plurality of lists of components to display at the user interface of the device associated with the user.

10. The method of claim 1, wherein:
receiving the request signal comprises receiving the request signal including a list of candidate sources for servicing the list of components; and
applying the scoring machine-learning model comprises applying the scoring machine-learning model to generate the confidence score of a list of candidate scores that is indicative of the likelihood that the list of components are located at each candidate source from the list of candidate sources, and the method further comprising:
sending, via the interface, the list of confidence scores to the online platform, wherein the sending causes the online platform to use the list of candidate scores to select the source for servicing the list of components and display the user interface with the list of components and the selected source for servicing the list.

11. The method of claim 1, wherein:
receiving the request signal comprises receiving the request signal including a list of candidate sources for servicing the list of components; and
applying the scoring machine-learning model comprises applying the scoring machine-learning model to generate the confidence score of a list of candidate scores that is indicative of the likelihood of servicing the list of components using each candidate source from the list of candidate sources, and the method further comprising:
ranking, using the list of candidate scores, the list of candidate sources to generate a ranked list of candidate sources; and
sending, via the interface, the ranked list of candidate sources to the online platform, wherein the sending causes the online platform to use the ranked list of candidate sources to select the source for servicing the list of components and display the user interface with the list of components and the selected source for servicing the list.

12. A computer program product comprising a non-transitory computer readable storage medium having instructions encoded thereon that, when executed by a processor, cause the processor to perform steps comprising:
receiving, from an online platform and via an interface of an online system, a request signal including a list of components and an identity of a user of the online system;
responsive to the received request signal, identifying, from an item database of the online system, a set of one or more candidate items that match each component from the list;
comparing each component from the list with one or more embeddings of the set of one or more candidate items to generate a matching score indicating how much each component from the list matches the set of one or more candidate items;
identifying a number of matches for each component from the list indicating a number of candidate items in the set of one or more candidate items;
accessing a scoring machine-learning model of the online system, wherein the scoring machine-learning model is trained using information about past engagements of a collection of users of the online system with a plurality of lists of components to predict a likelihood that the list of components are located at a source;
applying the scoring machine-learning model to the matching score for each component from the list, the number of matches for each component from the list, and past conversion data for the user to generate a confidence score for the list of components that is indicative of the likelihood that the list of components are located at the source;
comparing the confidence score to a threshold score;
selecting, based on identifying that the confidence score meets or exceeds the threshold score, the list of components for the source;
responsive to selecting the list of components for the source, generating a user interface signal; and
sending, via a network, the user interface signal to a device associated with the user, wherein the sending causes the device to display a user interface with the list of components and an identification of the source where the list of components are located.

13. The computer program product of claim 12, wherein the instructions further cause the processor to perform steps comprising:
receiving, from the online platform and via the interface of the online system, the request signal including at least one of information about the source for servicing the list of components, or information about a set of filters for filtering the item database to identify the set of one or more candidate items that match each component from the list.

14. The computer program product of claim 12, wherein the instructions further cause the processor to perform steps comprising:
responsive to the received request signal, identifying, from the item database, an initial set of candidate items that match each component from the list;
applying, for each component from the list, an availability machine-learning model to information about each candidate item from the initial set and inventory data related to the source to generate an availability score that is indicative of a likelihood of availability of each candidate item at the source; and
identifying the set of one or more candidate items by selecting, for each component from the list and based on the availability score for each candidate item, the set of one or more candidate items from the initial set of candidate items, the set of one or more candidate items are predicted to be available at the source.

15. The computer program product of claim 14, wherein the instructions further cause the processor to perform steps comprising:
filtering, based at least in part on the past conversion data for the user, one or more candidate items from the initial set of candidate items to identify the set of one or more candidate items for each component from the list; and
selecting, based at least in part on information about the user, the source for servicing the list of components.

16. The computer program product of claim 12, wherein the instructions further cause the processor to perform steps comprising:
generating training data including the information about past engagements of the collection of users of the online system with the plurality of lists of components and information about availability of each component from the plurality of lists for conversion by a user from the collection of users;
training, using the training data, the scoring machine-learning model to generate a set of initial values for a set of parameters of the scoring machine-learning model;
receiving, from the device associated with the user and via a network, feedback data with information about whether each component from the list was available for conversion at the source; and
re-training the scoring machine-learning model by updating, using the feedback data, the set of parameters of the scoring machine-learning model.

17. The computer program product of claim 12, wherein the instructions further cause the processor to perform steps comprising:
sending, via the interface, the confidence score to the online platform, wherein the sending causes the online platform to use the confidence score for ranking a plurality of lists of components and determining one or more of the plurality of lists of components to display at the user interface of the device associated with the user.

18. The computer program product of claim 12, wherein the instructions further cause the processor to perform steps comprising:
receiving the request signal including a list of candidate sources for servicing the list of components;
applying the scoring machine-learning model to generate the confidence score of a list of candidate scores that is indicative of the likelihood that the list of components are located at each candidate source from the list of candidate sources; and
sending, via the interface, the list of confidence scores to the online platform, wherein the sending causes the online platform to use the list of candidate scores to select the source for servicing the list of components and display the user interface with the list of components and the selected source for servicing the list.

19. The computer program product of claim 12, wherein the instructions further cause the processor to perform steps comprising:
receiving the request signal including a list of candidate sources for servicing the list of components;
applying the scoring machine-learning model to generate the confidence score of a list of candidate scores that is indicative of the likelihood that the list of components are located at each candidate source from the list of candidate sources;
ranking, using the list of candidate scores, the list of candidate sources to generate a ranked list of candidate sources; and
sending, via the interface, the ranked list of candidate sources to the online platform, wherein the sending causes the online platform to use the ranked list of candidate sources to select the source for servicing the list of components and display the user interface with the list of components and the selected source for servicing the list.

20. A computer system comprising:
a processor; and
a non-transitory computer-readable storage medium having instructions that, when executed by the processor, cause the computer system to perform steps comprising:
receiving, from an online platform and via an interface of an online system, a request signal including a list of components and an identity of a user of the online system;
responsive to the received request signal, identifying, from an item database of the online system, a set of one or more candidate items that match each component from the list;
comparing each component from the list with one or more embeddings of the set of one or more candidate items to generate a matching score indicating how much each component from the list matches the set of one or more candidate items;
identifying a number of matches for each component from the list indicating a number of candidate items in the set of one or more candidate items;
accessing a scoring machine-learning model of the online system, wherein the scoring machine-learning model is trained using information about past engagements of a collection of users of the online system with a plurality of lists of components to predict a likelihood that the list of components are located at a source;
applying the scoring machine-learning model to the matching score for each component from the list, the number of matches for each component from the list, and past conversion data for the user to generate a confidence score for the list of components that is indicative of the likelihood that the list of components are located at the source;
comparing the confidence score to a threshold score;
selecting, based on identifying that the confidence score meets or exceeds the threshold score, the list of components for the source;
responsive to selecting the list of components for the source, generating a user interface signal; and
sending, via a network, the user interface signal to a device associated with the user, wherein the sending causes the device to display a user interface with the list of components and an identification of the source where the list of components are located.
